(19) United States
(12) Patent Application Publication
(10) Pub. No.: US 2026/0024033 A1
(43) Pub. Date: Jan. 22, 2026

(54) SYSTEMS, METHODS, AND DEVICES FOR INTEGRATED WEB-BASED TASK MANAGEMENT

(71) Applicant: Central Painting Inc., Barrie (CA)

(72) Inventors: Scott Kenneth Gribbon, Corbeil (CA); David John Graham, Barrie (CA); Sean Patrick Hamill, Barrie (CA); Benjamin Delainey Anderson, Spruce Grove (CA)

(21) Appl. No.: 19/245,030

(22) Filed: Jun. 20, 2025

Related U.S. Application Data
(60) Provisional application No. 63/672,078, filed on Jul. 16, 2024.

(51) Int. Cl. G06Q 10/0631

(52) U.S. Cl. CPC G06Q 10/063114

(57) ABSTRACT

A task management system, method, and device for managing a project are provided. The system includes a task management server configured to create, assign, and track tasks in real time, continuously monitor progress of the tasks in real time by collecting task data, analyze the task data to generate real-time progress reports, synchronize, in real time, updates or changes to detailed worksite information, integrate data streams related to the progress of the tasks and budget utilization to provide a unified view of the status of the project, and manage subtasks, record time and resource utilization, and analyze, a database connected to the task management server and configured to collect, organize, and manage the detailed worksite information and a user terminal configured to align deadlines of the tasks with a schedule of the project and visually manage assignment of the tasks.

### TECHNICAL FIELD

The following relates generally to systems, methods, and devices for managing service-based operations, and more particularly to systems, methods, and devices for integrated web-based task management.

### INTRODUCTION

In the service and trades industry, particularly in the domains of construction and home improvement, the management of tasks and resources has traditionally been a manual and cumbersome process. Traditional methods often rely on physical paperwork, direct communication via phone calls, and manual tracking of job progress. These methods are prone to errors, miscommunications, and inefficiencies, which may result in delays, increased costs, and reduced customer satisfaction. As businesses scale, the complexity of managing multiple job sites, diverse teams, and various tasks simultaneously becomes increasingly challenging. Therefore, there is a need for an integrated system that may streamline these operations.

Earlier attempts to digitize task management in the construction and home improvement industries have often been piecemeal, addressing only specific aspects of the workflow. Some systems focus solely on scheduling, while others may handle inventory management or employee time tracking. However, these disparate solutions lack integration, leading to siloed data and inefficiencies in information flow. The absence of a unified system means that information must be manually transferred between systems, increasing the risk of data loss or errors and reducing overall operational efficiency.

Yet another problem with existing systems is their limited capability to manage and integrate various types of data. Construction and home improvement projects involve numerous data points, including task assignments, material inventories, labor hours, and quality checks. Current systems often struggle to provide a cohesive view of this data, resulting in fragmented information that is difficult to analyze and act upon. This fragmentation hinders the ability of managers to make informed decisions, allocate resources efficiently, and ensure the timely completion of projects.

The manual nature of traditional task management also poses significant challenges in terms of scalability. As projects grow in size and complexity, the effort required to manage them increases exponentially. This often results in delays, errors, and increased administrative overhead.

Therefore, there is a clear need for a comprehensive, integrated system that may address these issues and provide a seamless, efficient, and transparent solution for managing tasks and resources. Accordingly, systems, methods, and devices are desired that overcome one or more disadvantages associated with existing task management solutions, particularly towards providing task management in home improvement and construction industries.

### SUMMARY

A task management system for managing a project is provided. The task management system includes a task management server configured to create, assign, and track tasks in real time, continuously monitor progress of the tasks in real time by collecting task data, analyze the task data to generate real-time progress reports, synchronize, in real time, updates or changes to detailed worksite information throughout the system, integrate data streams related to the progress of the tasks and budget utilization to provide a unified view of the status of the project, and manage subtasks, record time and resource utilization, and analyze to ensure the tasks are evenly distributed, a database connected to the task management server and configured to collect, organize, and manage the detailed worksite information, and a user terminal connected to the task management server over a network and configured to align deadlines of the tasks with a schedule of the project, and visually manage assignment of the tasks.

The detailed worksite information may include site layouts and safety protocols.

The task management server may be further configured to provide a graphical user interface for the user terminal to visually manage the assignment of the tasks on interactive floor plans.

The task management server may be further configured to enforce multi-level access controls based on user roles.

The task management system may further include a contractor terminal connected to the task management server over a network, configured to allow contractors and workers to receive the assignments of the tasks, update statuses of the tasks, and report on the progress of the project.

The task management system may further include a client terminal connected to the task management server over a network, configured to provide clients with real-time updates on project status and allow clients to provide feedback or approve completed tasks.

A task management device for managing a project is provided. The task management device includes a task management module configured to create, assign, and track tasks in real time, continuously monitor progress of the tasks in real time by collecting task data, analyze the task data to generate real-time progress reports, and align deadlines of the tasks with a schedule of the project, a job site management module configured to collect, organize, and manage the detailed worksite information, and synchronize, in real time, updates or changes to detailed worksite information throughout the device, a task assignment module configured to integrate data streams related to the progress of the tasks and budget utilization to provide a unified view of the status of the project, and a detailed task management module configured to manage subtasks, record time and resource utilization, and analyze to ensure the tasks are evenly distributed.

The task management device may further include a multi-level access control module configured to enforce role-based access controls.

The task management device may further include a database configured to store task descriptions, employee assignments, material inventories, and project timelines.

The database may be further configured to store progress reports, client feedback, and visual data such as photos and PDF documents.

The task management device may be further configured to synchronize data between the task management device and external user terminals over a network, thereby facilitating real-time updates and communication.

The detailed worksite information may include site layouts and safety protocols.

The task management server may be further configured to provide a graphical user interface for the user terminal to visually manage the assignment of the tasks on interactive floor plans.

A task management method for managing a project is provided. The method includes creating, assigning, and tracking tasks, continuously monitoring progress of the tasks in real time by collecting task data, analyzing the task data to generate real-time progress reports, aligning task deadlines with a schedule of the project, collecting, organizing, and managing detailed worksite information, synchronizing updates or changes to the detailed worksite information, integrating data streams related to task progress and budget utilization to provide a unified view of status of the project, managing subtasks, recording time and resource utilization, and analyzing to ensure that tasks are evenly distributed.

The detailed worksite information may include site layouts and safety protocols.

The method may further include providing a graphical user interface to visually manage the assignment of the tasks on interactive floor plans.

The method may further include enforcing multi-level access controls based on user roles.

The method may further include storing, on a database, task descriptions, employee assignments, material inventories, and project timelines.

The database may be further configured to store progress reports, client feedback, and visual data such as photos and PDF documents.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of systems, methods, and devices of the present specification. In the drawings:

FIG. 1 is a schematic diagram of a system for integrated task management, according to an embodiment;

FIG. 2 is a block diagram of a device for integrated task management, according to an embodiment;

FIG. 3 is a block diagram of a system for integrated task management, according to an embodiment;

FIG. 4 is a flow chart of a method for integrated task management, according to an embodiment;

FIGS. 5A-5C are graphical user interfaces (GUIs) showing completion of sub-tasks, according to respective embodiments;

FIGS. 6A-6C are GUIs showing completion of tasks, according to respective embodiments;

FIGS. 7A-7B are GUIs showing completion of tasks, according to respective embodiments; and

FIGS. 8A-8B are GUIs showing creation of tasks, according to respective embodiments.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, a server, a personal computer, a cloud based program or system, a laptop, personal data assistants, cellular telephone, smartphone, or tablet device.

Each program is preferably implemented in a high-level procedural or object oriented programming and/or scripting language to communicate with a computer system. However, the programs may be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of more than one device or article.

While the present apparatus and processes have been described with reference to particular embodiments, it should be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

In this regard, the scope of the present apparatus and processes is not limited to the specific embodiments disclosed herein. Other variations, modifications, and alternatives are also within the scope of the present apparatus and processes. The appended claims are intended to cover such variations, modifications, and alternatives as fall within their true spirit and scope.

Additionally, the present disclosure is not limited to the described methods, systems, devices, and apparatuses, but includes variations, modifications, and other uses thereof as come within the scope of the appended claims. The detailed description of the embodiments and the drawings are illustrative and not restrictive.

The following relates generally to systems, methods, and devices for managing service-based operations, and more particularly to systems, methods, and devices for integrated web-based task management.

The subject matter disclosed herein pertains to an integrated system for streamlining the management of tasks and resources in construction and home improvement projects. This system may advantageously enhance efficiency, accuracy, and real-time monitoring of various project activities. The system utilizes a network of servers, databases, client terminals, and data processing algorithms to manage and oversee the entire lifecycle of construction and home improvement tasks.

In an embodiment, the task processing device comprises a task management module that provides for online task management. The task management module assigns, tracks, and manages tasks in real time. The task management module breaks down complex projects into manageable tasks and subtasks, assigns them to the appropriate personnel, and monitors progress. The task management module is configured to analyze data from multiple sources, including worker inputs, material inventories, and project timelines, to update task statuses. This ensures that all stakeholders have access to the most current information, enabling informed decision-making and efficient project management.

In an embodiment, the task processing device includes a job site management module. The job site management module is configured to collect and organize detailed worksite information, including task descriptions, employee assignments, material usage, and progress reports. The worksite information is stored in a memory unit and may be accessed and modified in real time by authorized users. The job site management module continuously synchronizes data across the system, ensuring that all site information is accurate and up-to-date. This real-time data synchronization facilitates efficient site management and oversight, reducing the likelihood of errors and delays.

In an embodiment, the task processing device features a task assignment module. The task assignment module utilizes graphical data processing to manage floor plans and task assignments visually. Users may upload digital drawings, and the module converts these drawings into interactive floor plans. Tasks may be assigned to specific areas within the drawings, and the module tracks their progress in real-time. The graphical user interface allows users to view and manage tasks directly on the floor plan, enhancing clarity and precision in task assignments and improving overall project coordination.

In an embodiment, the task processing device integrates a detailed task management module. The detailed task management module manages subtasks, assigns them to workers, and records time and resource utilization. The detailed task management module analyzes data on time and resource utilization to ensure that tasks are evenly distributed and that resources are used efficiently. The detailed task management module dynamically updates the status of tasks based on real-time data inputs, such as the completion of specific stages like priming or applying the first coat of paint. This ensures granular control over every aspect of task management, facilitating efficient resource allocation and timely project completion.

In an embodiment, the task processing device includes a multi-level access control module. The multi-level access control module regulates access to different functionalities based on user roles, such as administrators, clients, and workers. The multi-level access control module enforces role-based access controls, ensuring that each user may only access the information and tools relevant to their role. This hierarchical access structure enhances security by preventing unauthorized access and improves operational efficiency by streamlining user interactions with the system.

In an embodiment, the task processing device features a real-time data processing module. The real-time data processing module processes comprehensive task data, including task descriptions, time logs, material usage, worker assignments, and client feedback, in real-time. The real-time data processing module continuously collects and analyzes task data from various sources, including job sites, worker inputs, and client feedback. This task data is used to generate real-time progress reports, which are then made available to all stakeholders. The real-time data processing module also handles the integration of visual data, such as photos and PDF documents, into the system, providing a comprehensive view of project progress and enabling stakeholders to make informed decisions based on up-to-date information.

In an embodiment, the task processing device incorporates a dynamic construction stage management module. The dynamic construction stage management module tracks the progress of tasks through various stages, such as initial setup, priming, painting, and quality control. By integrating data streams related to task progress and budget utilization, the dynamic construction stage management module provides a unified view of project status. This integration may advantageously ensure that projects stay on track and within budget. The dynamic construction stage management module uses sophisticated algorithms to calculate performance indices, which are visualized through color-coded progress bars. This real-time, data-driven approach to task management enhances the overall efficiency and effectiveness of construction and home improvement projects.

Overall, the integrated system leverages advanced data processing algorithms, real-time data synchronization, and a robust access control functionality to offer a comprehensive platform for efficient, accurate, and transparent task management. The various modules within the task processing device work together seamlessly to provide a unified, cohesive approach to project management, addressing many of the inefficiencies and challenges faced by traditional methods.

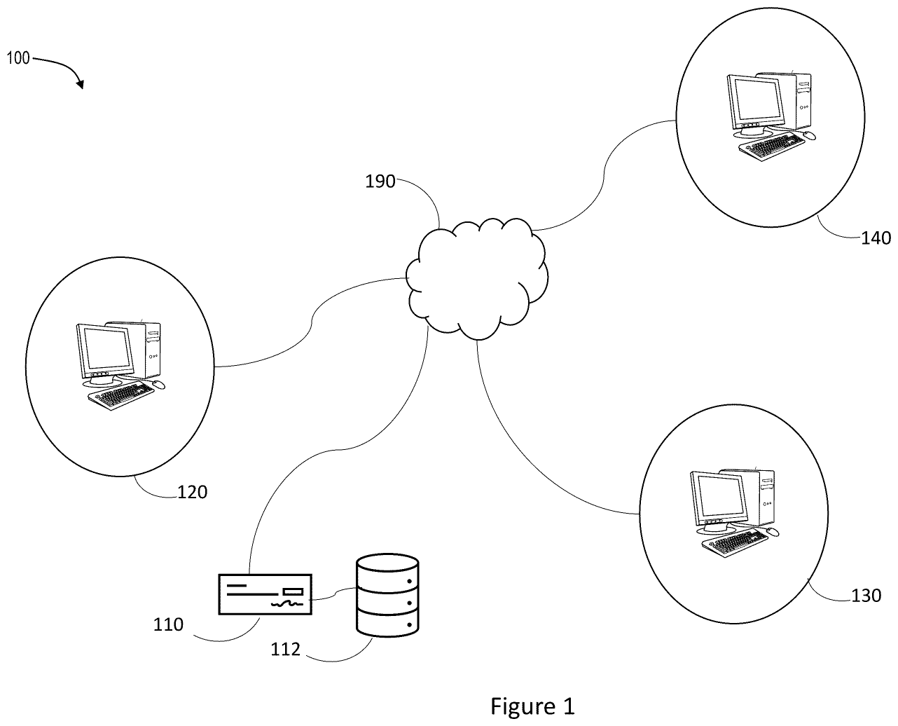

Referring now to FIG. 1, shown therein is a block diagram illustrating a system 100 for integrated task management, according to an embodiment.

The system 100 includes a task management server 110. The task management server 110 is configured to perform task management, including task assignment, progress tracking, data processing, and real-time updates. The task management server 110 is the central hub of the system 100 and is configured to manage and coordinate all activities related to construction and home improvement projects.

The task management server 110 assigns, tracks, and manages tasks in real-time, breaking down complex projects into manageable tasks and subtasks. The task management server 110 assigns these tasks and sub-tasks to the appropriate personnel and monitors their progress continuously. By analyzing data from multiple sources, including worker inputs, material inventories, and project timelines, the server ensures that all stakeholders have access to the most current information, e.g., in respect of the tasks and the sub-tasks.

The task management server 110 provides comprehensive management of job sites by collecting and organizing detailed worksite information, including task descriptions, employee assignments, material usage, and progress reports. This information is stored in a secure memory unit (not shown) and may be accessed and modified in real-time by authorized users. The task management server 110 continuously synchronizes this data across the system, ensuring that all site information is accurate and up-to-date. This real-time data synchronization facilitates efficient site management and oversight, reducing the likelihood of errors and delays.

The task management server 110 is configured for task assignment by utilizing graphical data processing to manage floor plans and task assignments visually. Users may upload digital drawings, and the task management server 110 converts these drawings into interactive floor plans. Tasks may be assigned to specific areas within the drawings, and the task management server 110 tracks progress in real-time. This graphical user interface allows users to view and manage tasks directly on the floor plan, enhancing clarity and precision in task assignments and improving overall project coordination.

The task management server 110 integrates detailed task management functions into its core processing capabilities. The task management server 110 manages subtasks, assigns them to workers, and records time and resource utilization. By analyzing data on time and resource utilization, the server 110 ensures that tasks are evenly distributed and that resources are used efficiently. The task management server 110 dynamically updates the status of tasks based on real-time data inputs, such as the completion of specific stages like priming or applying the first coat of paint. This functionality ensures granular control over every aspect of task management, facilitating efficient resource allocation and timely project completion.

The task management server 110 further provides multi-level access control functionality to the system 10. This system regulates access to different functionalities based on user roles, such as administrators, clients, and workers. The server enforces role-based access controls, ensuring that each user may only access the information and tools relevant to their role. This hierarchical access structure enhances security by preventing unauthorized access and improves operational efficiency by streamlining user interactions with the system.

The task management server 110 is configured to process comprehensive task data in real-time. This data includes task descriptions, time logs, material usage, worker assignments, and client feedback. The server 110 continuously collects and analyzes task data from various sources, including job sites, worker inputs, and client feedback. This task data is used to generate real-time progress reports, which are made available to all stakeholders. The task management server 110 further handles the integration of visual data, such as photos and PDF documents, into the system 100, providing a comprehensive view of project progress and enabling stakeholders to make informed decisions based on up-to-date information.

The task management server 110 further manages dynamic construction stage implementation. The task management server 110 tracks the progress of tasks through various stages, such as initial setup, priming, painting, and quality control. By integrating data streams related to task progress and budget utilization, the server 110 provides a unified view of project status. This integration may advantageously ensure that projects stay on track and within budget. The server 110 uses sophisticated algorithms to calculate performance indices, which are visualized through color-coded progress bars. This real-time, data-driven approach to task management significantly enhances the overall efficiency and effectiveness of construction and home improvement projects.

The task management server 110 provides for real-time updates and synchronization across all user terminals, including the user terminal 120, the contractor terminal 130, and the client terminal 140, as will be further discussed hereinbelow. By providing a seamless flow of information, the server 110 provides that all stakeholders are kept informed about the current status of tasks, the progress reports, and any changes in project plans. This real-time communication enhances collaboration and coordination among all parties involved in the project.

The task management server 110 is scalable and robust, capable of handling large volumes of data and multiple simultaneous projects. The task management server 110 employs advanced data processing algorithms and secure data storage techniques to ensure the integrity and reliability of the information. The architecture of the server 110 allows for easy integration with additional components, such as backup servers and redundant databases, to provide failover capabilities and ensure continuous operation even in the event of hardware or software failures. This scalability and robustness allow the task management server 110 to manage and execute complex construction and home improvement projects efficiently and effectively.

The task management server 110 is connected to a database 112. The database 112 is configured to store task descriptions, employee assignments, material inventories, project timelines, the progress reports, client feedback, and visual data such as photos and PDF documents. The database 112 ensures that all data is securely stored and may be efficiently retrieved by the server 110 as needed. The server 110 and database 112 work in tandem to provide real-time data synchronization and ensure that all information is up-to-date and accurate.

When tasks are created or modified by the task management server 110, detailed descriptions of the tasks are stored in the database 112. This includes information such as task objectives, assigned personnel, deadlines, and priority levels. The server 110 continuously updates the database 112 with the latest task information to ensure that the data remains current and reliable. Additionally, the database 112 maintains historical records of task modifications, providing a comprehensive audit trail that may be referenced for accountability and tracking purposes.

The database 112 is configured to manage employee assignments. As the task management server 110 assigns tasks to specific employees, the server 110 records these assignments in the database 112, including the names of the employees, their roles, and the tasks assigned to them. This data allows the server 110 to monitor workload distribution and ensure that tasks are allocated efficiently. The database 112 further stores information on employee availability and skill sets, enabling the server 110 to make informed decisions when assigning tasks based on the best match of employee capabilities to project requirements.

The database 112 further handles the storage of material inventories and project timelines. Material inventories include detailed records of all materials required for the project, quantities, suppliers, and current stock levels. The task management server 110 updates the database 112 with information on material usage and deliveries, ensuring that inventory levels are accurately tracked and managed. Project timelines, which outline the schedule of tasks and milestones, are also stored in the database 112. The server 110 uses this timeline data to track progress and ensure that projects are on schedule. By maintaining up-to-date inventory and timeline information, the database 112 helps prevent resource shortages and scheduling conflicts.

The progress reports and client feedback are stored in the database 112. The task management server 110 generates the progress reports based on real-time data collected from various sources, including task updates and visual inspections. The progress reports are stored in the database 112 and may be accessed by authorized users to monitor project progress. Client feedback, collected through various terminals (e.g., the client terminal 140), is also stored in the database 112, providing valuable insights into client satisfaction and areas for improvement. Visual data such as photos and PDF documents are integrated into the system by the server 110 and stored in the database 112, offering a comprehensive view of project status and facilitating detailed progress tracking.

The interaction between the task management server 110 and the database 112 may be characterized by continuous data transfers that ensure seamless synchronization and up-to-date information. The server 110 frequently queries the database 112 to retrieve the latest data for processing and decision-making. Conversely, the server 110 updates the database 112 with new and modified data to reflect the current state of the project. This bidirectional data flow is optimized for speed and reliability, employing advanced data transfer protocols and security measures to protect data integrity and confidentiality. By maintaining a robust and synchronized data exchange, the server 110 and database 112 together support the efficient management and execution of construction, painting, and home improvement projects.

The system 100 further includes the user terminal 120 connected to the task management server 110 over a network 190. The user terminal 120 is operated by project managers and administrators to access the server 110 functionalities. The user terminal 120 provides for assigning tasks, tracking progress, managing resources, and generating the reports. The user terminal 120 provides a comprehensive interface for managing all aspects of the project.

The user terminal 120 serves as the primary interface for project managers and administrators to interact with the task management system. The user terminal 120 is equipped with a graphical interface that enables users to easily navigate through different functionalities. Through this interface, users may create and assign tasks, specifying details such as task descriptions, deadlines, priority levels, and assigned personnel. The user terminal 120 sends these task assignments to the task management server 110, which then processes and distributes the tasks accordingly.

The user terminal 120 is configured for progress tracking. Project managers and administrators monitor the real-time status of all tasks and subtasks via the terminal. The terminal 120 displays progress updates received from the task management server 110, including visual indicators such as color-coded progress bars and status icons. This real-time visibility into task progress allows users to quickly identify any delays or issues and take corrective actions to keep the project on track.

The user terminal 120 is configured to provide resource management. Users may manage both human and material resources through the terminal. This includes assigning tasks to specific employees based on their availability and skill sets, as well as managing the inventory of materials required for the project. The user terminal 120 allows users to view and update resource allocations, ensuring that the right resources are available at the right time. The user terminal 120 communicates these updates to the task management server 110, which adjusts the overall project plan accordingly.

The user terminal 120 further provides reporting tools. Users may generate various reports to gain insights into project performance. These reports may include detailed information on task completion rates, resource utilization, budget status, and overall project progress. The terminal 120 allows users to customize report parameters and formats to meet specific needs. Once generated, these reports may be viewed on the terminal or exported for further analysis and sharing with stakeholders. The task management server 110 continuously updates the data used for reporting, ensuring that the reports reflect the most current information.

Additionally, the user terminal 120 supports communication and collaboration among project stakeholders. Users may send and receive messages, share documents, and provide feedback through the user terminal 120. This integrated communication feature maintains clear and consistent communication throughout the project lifecycle. By facilitating seamless interaction between project managers, administrators, and other stakeholders, the user terminal 120 enhances coordination and teamwork, contributing to the overall success of the project.

The user terminal 120 is configured to handle the demands of large and complex projects. The user terminal 120 is built with high-performance hardware and optimized software to ensure responsive and reliable operation. The user terminal 120 is further equipped with security features to protect sensitive project data. Access controls, encryption, and authentication mechanisms are implemented to safeguard information and ensure that only authorized users may access the system 100. These security measures, combined with the robust functionality of the user terminal 120, provide a secure and efficient platform for managing construction and home improvement projects.

The system 100 further includes the contractor terminal 130 connected to the task management server 110 over the network 190. The contractor terminal 130 is configured to be operated by contractors and workers to receive task assignments, update task statuses, and report on progress. The contractor terminal 130 allows contractors and workers to view their assigned tasks, input data on work completed, and access relevant site information.

The contractor terminal 130 operates as the primary interface for contractors and workers to interact with the task management system 100. The contractor terminal 130 is designed with a user-friendly interface that facilitates easy access to task information and reporting tools. Through the terminal 130, workers receive their task assignments directly from the task management server 110. These assignments include detailed descriptions of the tasks, deadlines, priority levels, and any specific instructions. The contractor terminal 130 ensures that workers have all the information they need to start and complete their tasks efficiently.

The contractor terminal 130 is configured to enable workers to update task statuses in real-time. As tasks are completed or progress is made, workers may input this information into the terminal. These updates are sent to the task management server 110, which processes the data and reflects the current status in the system 100. This real-time updating capability ensures that project managers and other stakeholders may advantageously always be aware of the latest progress, allowing them to make informed decisions and adjustments as needed.

The contractor terminal 130 further provides tools for reporting on work completed. Workers may use the terminal 130 to enter detailed reports on their tasks, including time spent, materials used, and any issues encountered. This data is transmitted to the task management server 110, which compiles it into comprehensive progress reports. These reports help project managers monitor the efficiency and effectiveness of the work being done, identify any potential problems, and ensure that the project stays on track.

The contractor terminal 130 may support communication between workers and project managers. Workers may send and receive messages, share updates, and ask for clarification on tasks through the terminal 130. This integrated communication feature helps maintain clear and consistent communication throughout the project, reducing the risk of misunderstandings and errors. By facilitating direct and timely communication, the terminal 130 enhances collaboration and ensures that any issues may be addressed promptly.

The system 100 further includes the client terminal 140 connected to the task management server 110 over the network 190. The client terminal 140 is configured to be operated by clients with access to real-time updates on the status of their projects. Clients may view progress reports, photos, and detailed descriptions of the work being performed. The client terminal 140 enhances transparency and allows clients to provide feedback or approve completed tasks directly through the system 100.

The client terminal 140 serves as an interface for clients to interact with the task management system 100, providing the clients with comprehensive access to project information and updates. The client terminal 140 is designed with an intuitive and user-friendly interface, making it easy for clients to navigate and find the information they need. The client terminal 140 connects to the task management server 110 to retrieve real-time data on project progress, ensuring that clients may advantageously always be informed about the current status of their projects.

The client terminal 140 is configured to provide access to the detailed progress reports. These reports are generated by the task management server 110 and include information on task completion rates, timelines, and any deviations from the project plan. Clients may view these reports to understand how their projects are progressing and identify any potential delays or issues. The reports are updated in real-time, reflecting the most recent data collected by the system, which ensures that clients have the latest information at their fingertips.

The client terminal 140 may allow clients to view visual data related to their projects. This may include photos of the job site, visual representations of task progress, and any relevant documents such as floor plans or material specifications. The visual data is integrated into the system 100 by the task management server 110 and stored in the database 112. By providing access to this visual data, the client terminal 140 offers a comprehensive view of the project, helping clients to better understand the work being performed and the current state of the job site.

The client terminal 140 is configured to receive feedback and task approval. Clients may use the client terminal 140 to provide feedback on the work being performed, ask questions, and request changes. This feedback is sent directly to the task management server 110, which processes the feedback and updates the relevant project data. Additionally, clients may approve completed tasks through the client terminal 140. This feature allows clients to review the work done, confirm that the completed work meets their expectations, and formally approve such completed work, ensuring that the project continues smoothly without unnecessary delays.

The client terminal 140 provides a direct line of communication between clients and project managers, allowing for quick resolution of any issues or concerns. Clients may send messages, receive updates, and stay in constant communication with the project team. This transparency builds trust and ensures that clients are fully aware of all aspects of their projects, from the initial planning stages to final completion.

The client terminal 140 is further configured for financial oversight. Clients may view budget reports, track expenses, and monitor financial performance against the project budget. The financial data, managed by the task management server 110 and stored in the database 112, is presented in an easy-to-understand format, helping clients to stay informed about the financial aspects of their projects. This feature ensures that clients may make informed decisions and manage their budgets effectively.

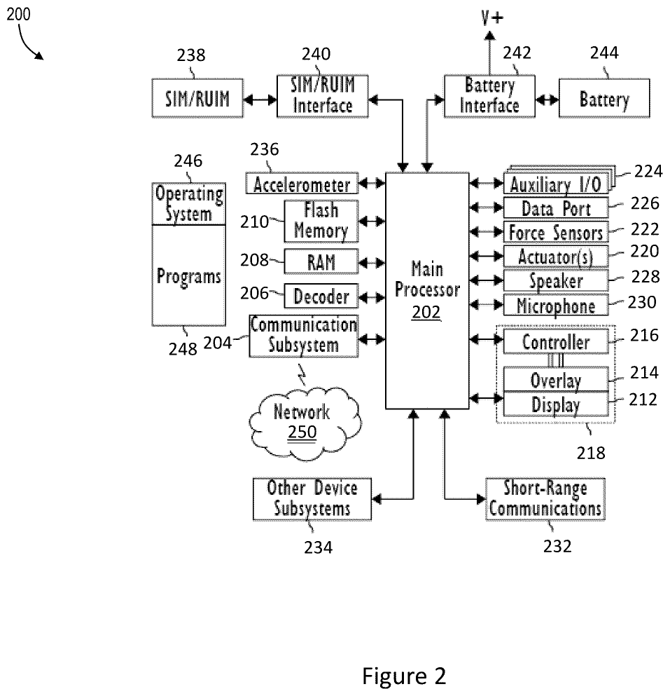

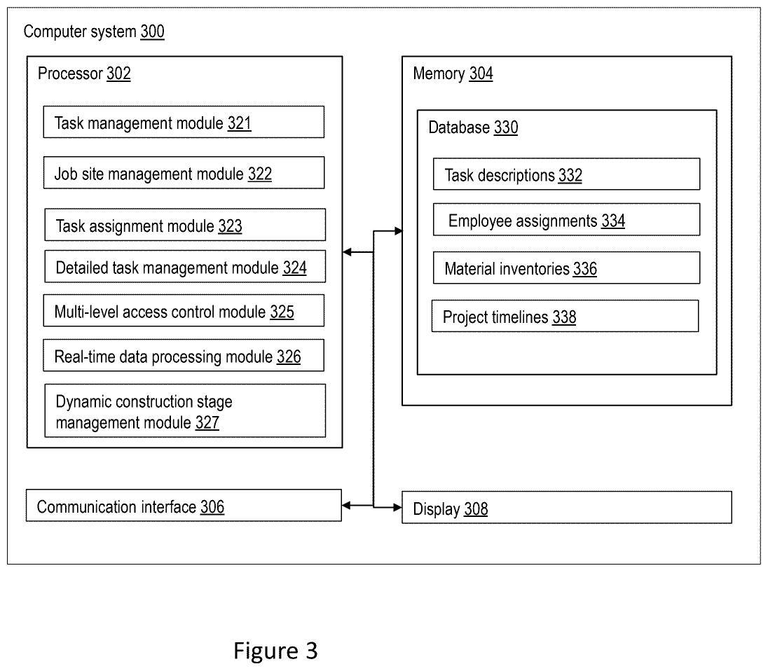

FIG. 2 shows a simplified block diagram of a device 200 of a task management system, according to an embodiment. The controller 200 may be any of the devices or components of the system 100 of FIG. 1. The controller 200 may be the system 300 of FIG. 3 as hereinbelow discussed.

The controller 200 includes a processor 202 that controls the operations of the controller 200. Communication functions, including data communications, voice communications, or both are performed through a communication subsystem 204. The communication subsystem 204 receives messages from, and sends messages to, a wireless network 250. Data received by the controller 200 is decompressed and decrypted by a decoder 206.

The wireless network 250 may be any type of wireless network, including, but not limited to, data-centric wireless networks, voice-centric wireless networks, and dual-mode networks that support both voice and data communications.

The controller 200 may be a battery-powered device and as shown includes a battery interface 242 for connecting one or more rechargeable batteries 244.

The processor 202 also interacts with additional subsystems such as a random access memory (RAM) 208, a flash memory 210, a display 212 (e.g., with a touch-sensitive overlay 214 connected to an electronic controller 216 that together comprise a touch-sensitive display 218), an actuator assembly 220, one or more optional force sensors 222, an auxiliary input/output (I/O) subsystem 224, a data port 226, a speaker 228, a microphone 230, short-range communications systems 232 and other device subsystems 234.

In some embodiments, user-interaction with the graphical user interface is performed through the touch-sensitive overlay 214. The processor 202 interacts with the touch-sensitive overlay 214 via the electronic controller 216. Information, such as text, characters, symbols, images, icons, and other items that may be displayed or rendered on a portable electronic device generated by the processor 202 may be displayed on the touch-sensitive display 218.

The processor 202 further interacts with an accelerometer 236 as shown in FIG. 2. The accelerometer 236 is utilized for detecting a direction of gravitational forces or gravity-induced reaction forces.

To identify a subscriber for network access according to the present embodiment, the controller 200 uses a subscriber identity module or a removable user identity module (SIM/RUIM) card 238 inserted into a SIM/RUIM interface 240 for communication with a network (such as the wireless network 250). Alternatively, user identification information may be programmed into the flash memory 210 or performed using other techniques.

The controller 200 further includes an operating system 246 and software components 248 that are executed by the processor 202 and which may be stored in a persistent data storage device such as the flash memory 210. Additional applications may be loaded onto the device 200 through the wireless network 250, the auxiliary 1/O subsystem 224, the data port 226, the short-range communications subsystem 232, or any other suitable device subsystem 234.

For example, in use, a received signal such as a text message, an e-mail message, web page download, or other data may be processed by the communication subsystem 204 and input to the processor 202. The processor 202 then processes the received signal for output to the display 212 or alternatively to the auxiliary 1/O subsystem 224. A subscriber may also compose data items, such as e-mail messages, for example, which may be transmitted over the wireless network 250 through the communication subsystem 204.

For voice communications, the overall operation of the controller 200 may be similar. The speaker 228 may output audible information converted from electrical signals, and the microphone 230 may convert audible information into electrical signals for processing.

Referring now to FIG. 3, shown therein is a block diagram of a task management system 300, according to an embodiment.

The system 300 includes a processor 302 for executing software modules.

The system 300 further includes a memory 304 for storing data, including output data from the processor 302. The memory 304 may be or may include the database 112 of FIG. 1.

The system 300 further includes a communication interface 306 for communicating with other devices, such as through receiving and sending data via a network connection (e.g., the network 190 of FIG. 1).

The system 300 further includes a display 308 for displaying various data generated by the system 300 in human-readable format.

The processor 302 includes a task management module 321 configured to handle the creation, assignment, and tracking of tasks within the system 300. The task management module 321 allows project managers to break down complex projects into manageable tasks and subtasks, specifying detailed descriptions, deadlines, priority levels, and required resources. By organizing tasks in a hierarchical structure, the task management module 321 ensures that aspects of the project are clearly defined and manageable. The task management module 321 communicates with task descriptions 332 in the memory 304 (e.g., stored as or on a database) to store and retrieve detailed information about each task.

The task management module 321 continuously monitors the progress of tasks in real-time. The task management module 321 collects updates from various sources, including worker inputs and progress reports, to ensure that the current status of each task is accurately reflected in the system 300. This real-time tracking enables project managers to quickly identify any delays or issues and take corrective actions. The module's 321 ability to provide up-to-date information enhances overall project management efficiency and helps keep projects on track.

Interaction with employee assignments set 334 and project timelines set 338 is performed by the task management module 321. By accessing the employee assignments set 334, the module 321 ensures that tasks are assigned to the appropriate personnel based on their availability and skills. The task management module 321 further retrieves timeline information from the project timelines set 338 to align task deadlines with the overall project schedule. This coordination helps maintain a balanced workload and ensures timely completion of all tasks.

The job site management module 322 is configured to collect, organize, and manage detailed information about job sites. The job site management module 322 captures a wide range of data, including site layouts, safety protocols, material requirements, and contact information. By maintaining a comprehensive profile for each job site, the module 322 ensures that all relevant information is easily accessible to authorized users. The module 322 interfaces with a material inventories set 336 stored in the memory 304 to track the materials needed and used on-site.

Real-time data synchronization is further performed by the job site management module 322. The job site management module 322 provides that any updates or changes to site information are promptly reflected across the system. This synchronization allows project managers and workers to have the most current information, reducing the risk of errors and improving decision-making. The module 322 advantageously provides accurate and up-to-date site information for efficient site management and oversight.

The job site management module 322 interacts with the task descriptions set 332 and project timelines set 338 to coordinate site activities with overall project tasks and schedules. By integrating these data sets, the module 322 advantageously ensures that all site activities are aligned with the project plan, enhancing coordination and efficiency. The job site management module 322 further accesses the employee assignments set 334 to manage site-specific employee roles and responsibilities, ensuring that the right personnel are assigned to the right tasks at each job site.

The task assignment module 323 utilizes graphical data processing to visually manage floor plans and task assignments. Users may upload digital drawings, which the module 323 converts into interactive floor plans, which may be stored in the memory 304 (e.g., as part of the task descriptions set 332). Tasks may be assigned to specific areas within these plans, providing a clear visual representation of task distribution. This module 323 interacts closely with the task descriptions set 332 to retrieve and display detailed task information.

Real-time progress tracking may be performed by the task assignment module 323. As tasks are assigned and updated, the module 323 tracks the progress of the tasks and displays such progress through the display 308. This real-time visualization helps project managers and workers understand the current status of tasks and identify any areas to which greater attention is to be paid or more resources or personnel to be assigned. The module 323 provides an interactive and visual approach to task assignment, thereby enhancing clarity and precision in task management.

The task assignment module 323 integrates data from the employee assignments set 334 and the material inventories set 336 to ensure that assigned tasks have appropriate resources and personnel. By accessing the employee assignments set 334 and the material inventories set 336, the module 323 ensures that tasks are assigned to available and qualified workers and that the indicated materials are on-site. Such integration helps prevent resource shortages and ensures that tasks may be completed efficiently and on time.

The processor 302 further includes a detailed task management module 324 configured to manage subtasks, record time and resource utilization, and ensure even distribution of work. The detailed task management module 324 allows project managers to break down tasks into smaller, more manageable components or sub-tasks and assign the sub-tasks to individual workers. The module 324 records detailed information about each subtask, including start and end times, resources used, and progress made. The module 324 communicates with the task descriptions set 332 to store and retrieve detailed subtask information in and from the memory 304, respectively.

Real-time data analysis may be performed by the detailed task management module 324. The detailed task management module 324 continuously collects data on time and resource utilization and analyzes this information to ensure that tasks are evenly distributed and resources are used efficiently. The module 324 updates the status of tasks based on real-time inputs, providing a granular view of project progress. This functionality helps maintain a balanced workload and ensures that resources are allocated optimally.

The detailed task management module 324 interacts with the employee assignments set 334 and the material inventories set 336 to coordinate subtask assignments with available resources. By accessing these data sets 334 and 336, the module 324 ensures that subtasks are assigned to the right personnel and that the indicated materials are available. This coordination helps prevent bottlenecks and may advantageously ensure that all tasks are completed on schedule. The module 324 further integrates with the project timelines set 338 to align subtask deadlines with the overall project timeline.

The processor 302 further includes a multi-level access control module 325 for regulating access to different functionalities based on user roles. The multi-level access control module 325 enforces role-based access controls, ensuring that each user may only access the information and tools relevant to their role. The multi-level access control module 325 accordingly maintains the security and integrity of the system 300 by preventing unauthorized access to sensitive data. The multi-level access control module 325 interfaces with all data sets stored in the memory 304, including the task descriptions set 332, the employee assignments set 334, the material inventories set 336, and the project timelines set 338, to control access permissions.

Role-based access may be provided by the multi-level access control module 325. The multi-level access control module 325 defines different access levels for various user roles, such as administrators, project managers, workers, and clients. Each role has specific permissions, allowing users to perform their tasks without accessing unnecessary information. This controlled access enhances operational efficiency by streamlining user interactions with the system and minimizing the risk of data breaches.

The multi-level access control module 325 continuously monitors user activities and updates access permissions as needed. Such updating advantageously ensures that access levels are adjusted in response to changes in user roles or project requirements. By maintaining up-to-date access controls, the module 325 helps protect sensitive information and may advantageously ensure that users have the necessary access to perform their duties effectively. The interaction of the multi-level access control module 325 with the foregoing data sets may further advantageously ensure that access permissions are consistently applied across the entire system 300.

The real-time data processing module 326 is configured for processing comprehensive task data in real-time. The real-time data processing module 326 collects and analyzes data from various sources, including job sites, worker inputs, and client feedback. The module 326 ensures that data is processed promptly and accurately, providing real-time updates to the system 300. The real-time data processing module 326 interacts with the foregoing data sets, including the task descriptions set 332, the employee assignments set 334, the material inventories set 336, and the project timelines set 338, to ensure that the most current information is available.

The real-time data processing module 326 further integrates visual data, such as photos and PDF documents, into the system 300. By processing this visual data alongside textual and numerical data, the module 326 provides a comprehensive view of project progress. This integration helps project managers and clients understand the current state of the project and make informed decisions. The interaction of the module 326 with the foregoing data sets ensures that all relevant information may advantageously be considered in real-time processing.

The processor 302 further includes a dynamic construction stage management module 327 for tracking the progress of tasks through various stages, such as initial setup, priming, painting, and quality control. The module 327 integrates data streams related to task progress and budget utilization to provide a unified view of project status. The module 327 ensures that all tasks are monitored throughout their lifecycle, from initiation to completion. The module 327 interacts with the task descriptions set 332 and the project timelines set 338 to align task stages with overall project schedules.

Real-time tracking and visualization is provided by the dynamic construction stage management module 327. The module 327 uses algorithms to calculate performance indices and visualize the performance indices through color-coded progress bars. Such visual indicators help project managers and workers to quickly assess the status of tasks and identify any problematic areas. The module 327 is configured to provide real-time, data-driven insights, which enhances the overall efficiency and effectiveness of project management by the system 300.

The dynamic construction stage management module 327 coordinates with the employee assignments set 334 and the material inventories set 336 to ensure that tasks progress smoothly through each stage. By accessing these data sets, the module 327 provides that the necessary personnel and materials are available at each stage of the task. This coordination helps prevent delays and ensures that tasks are completed on time and within budget. The module's integration with all data sets ensures a holistic approach to managing construction stages.

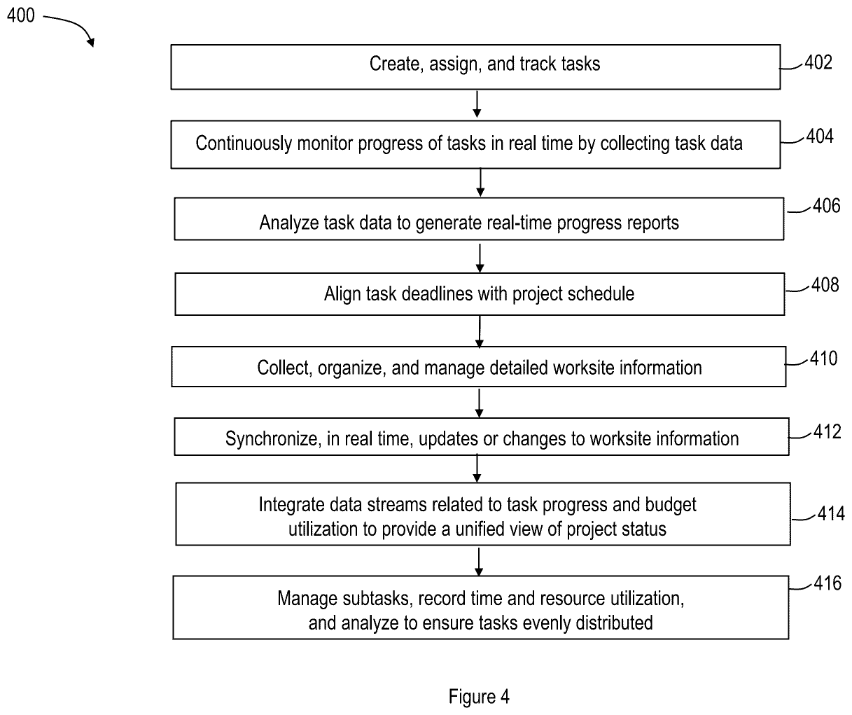

FIG. 4 shows a flow chart of method 400 for integrated task management in a project, according to an embodiment. The method 400 may be implemented by the system 100 (e.g., at the task management server 110) of FIG. 1. The method 400 may be implemented by the computer system 300 of FIG. 3.

At 402, the method 400 includes creating, assigning, and tracking tasks.

At 404, the method 400 includes monitoring progress of the tasks in real time by collecting task data. Such monitoring is advantageously continuous rather than discrete.

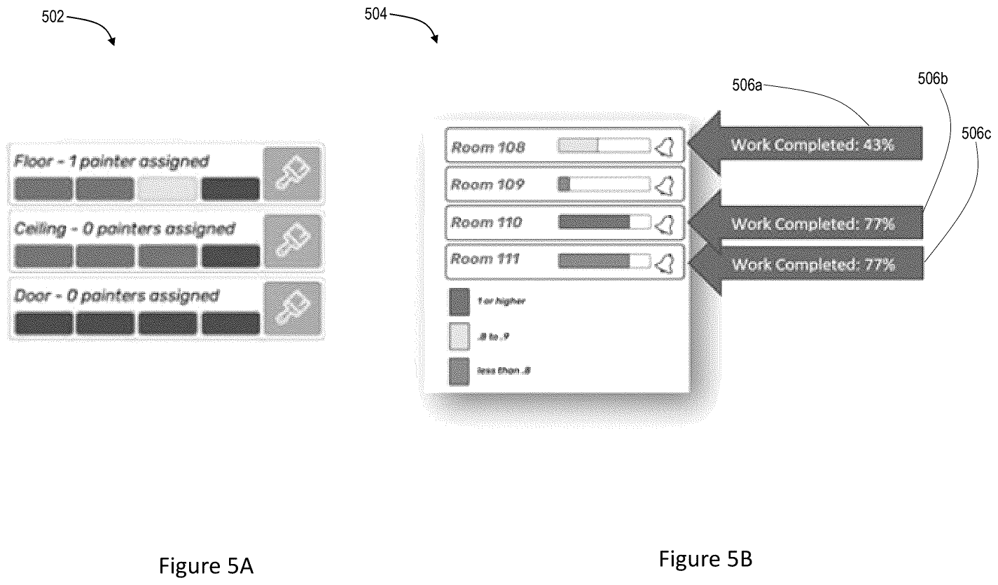

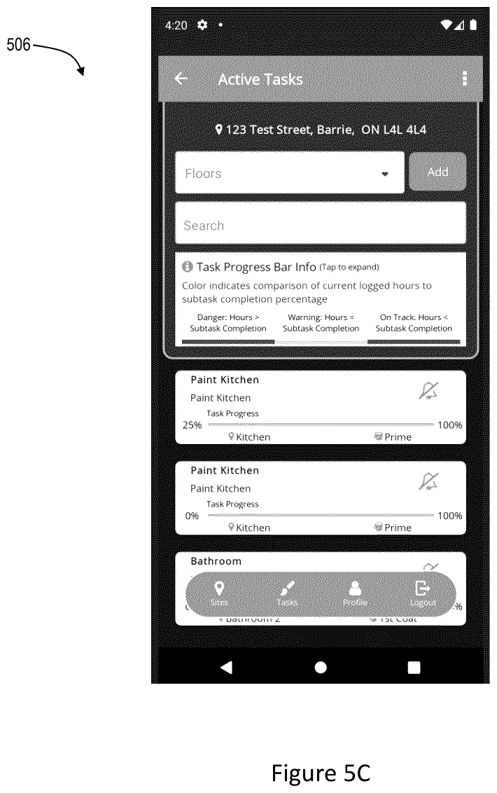

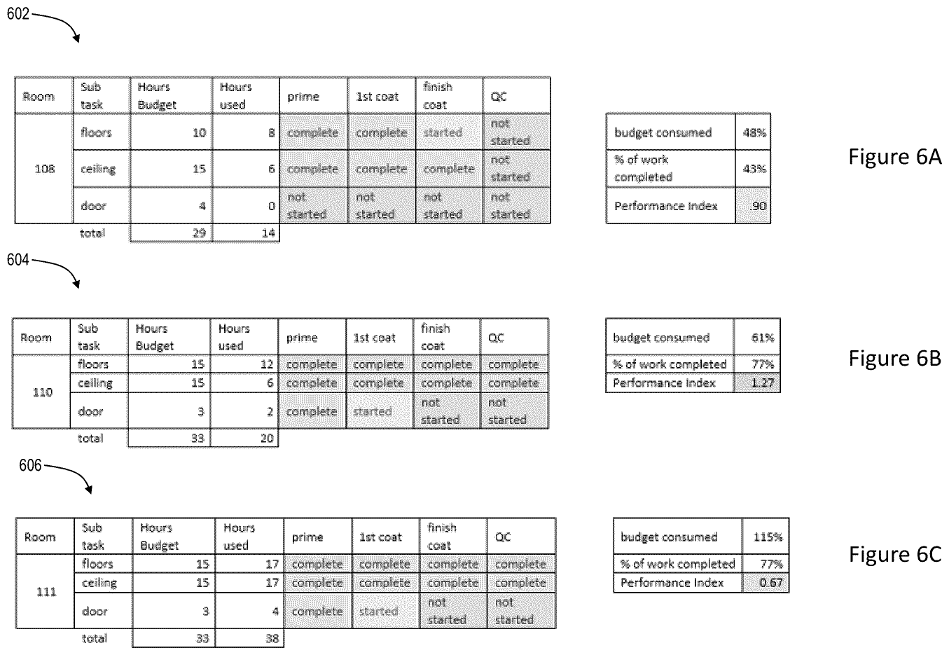

At 406, the method 400 includes analyzing the task data to generate real-time progress reports (e.g., the GUIs of FIGS. 5A-5B, 6A-6C). Because the monitoring to collect the task data is continuous, the progress reports are generated in real-time and so may be particularly detailed and responsive with respect to ongoing tasks.

At 408, the method 400 includes aligning task deadlines with a schedule of the project. Such alignment is performed based on the generated real-time progress reports.

At 410, the method 400 includes collecting, organizing, and managing detailed worksite information.

At 412, the method 400 includes synchronizing updates or changes to the detailed worksite information. Such synchronization is advantageously performed in real time. Such synchronization may be performed across all devices implementing the method 400 and/or all devices that send or receive data as the method 400 is performed. Where the method 400 is implemented by the system 100 or the computer system 300, such synchronization is performed throughout the system 100 or the computer system 300, respectively.

The method 400 may further include visually managing floor plans and task assignments.

At 414, the method 400 includes integrating data streams related to task progress and budget utilization to provide a unified view of project status. Such data streams may include one or more of the task data and the detailed site information.

At 416, the method 400 includes managing subtasks, recording time and resource utilization, and analyzing the foregoing to ensure that tasks are evenly distributed.

Referring now to FIGS. 5A, 5B, and 5C, shown therein are views of graphical user interfaces (GUIs) 502, 504, and 506 showing completion of sub-tasks (e.g., painting a floor, painting a ceiling, painting a door), a task (e.g., painting room 108), and another task (e.g., “Paint Kitchen”), according to respective embodiments. The GUI 504 includes arrows 506a, 506b, and 506c indicating task completion (e.g., painting room 108 being 43% complete) with colour coding according to performance indicators as will be further explained with respect to FIGS. 6A-6C.

Referring now to FIGS. 6A, 6B, and 6C, shown therein are views of GUIs 602, 604, and 606 showing completion of tasks for rooms 108, 110, and 111, according to respective embodiments.

Each of the GUIs 602-606 includes sub-tasks “prime”, “1^{st} coat”, “finish coat”, and quality check or “QC”, referring to painting rooms 108, 110, and 111. Each sub-task has a coloured status selected from the group consisting of “complete” (green), “started” (yellow), and “not started” (red).

A percentage measurement, estimate, or calculation of work completed (“% of work completed”) is provided as a fraction (converted to a percentage), the numerator being a sum of the number of sub-tasks completed (with a sub-task that is “started” or yellow being assigned a value of 0.2) and the denominator being the total number of sub-tasks. For example, in the GUI 602, 5 sub-tasks are completed (green) and one sub-task started (yellow) out of 12 sub-tasks total. Accordingly, the fractional calculation of work completed is 5.2/12, which is expressed as 43% in the GUI 602 (rounded down from 43.33%, repeating).

In FIGS. 6A-6C, an “hours budget” of time available for each task (e.g., for each room) is provided, and the “hours budget” is further broken down by sub-task. “Hours used” are similarly tracked with respect to each task and each sub-task.

In the GUIs 602-606, a performance index is provided (e.g., 0.90 (yellow) for the GUI 602) and calculated by dividing the percentage of work completed (e.g., 43% as hereinabove discussed) by the proportion of the hours budget consumed (e.g., 14 hours used out of 29 hours in the budget results in a percentage of 48%). In the GUI 602, 43% divided by 48% yields a performance index of 0.90 as shown in FIG. 6A.

When a room or task is selected, the supervisor of a project sees a breakdown of the sub-tasks (e.g., as shown in any of FIGS. 5A-5B, 6A-6C). In an embodiment, each sub-task is divided into the stages shown in FIGS. 5A-5B and 6A-6C, and the status of each subtask is shown.

In FIGS. 5A-5B, the progress bars adjacent the arrows 506a-506c show a percentage completion (indicated by the position of the coloured bar in between the left and right extremes). The progress bars are further coloured to indicate whether the project is on track relative to the budget (e.g., an hours budget as shown in FIGS. 6A-6C).

In an embodiment, a performance index above 0.90 is considered “on track” and is shown in green, while a performance index between 0.67 and 0.90 is considered “partially on track” and is shown in yellow, while a performance index of 0.67 or below is considered “off track” and is shown in red.

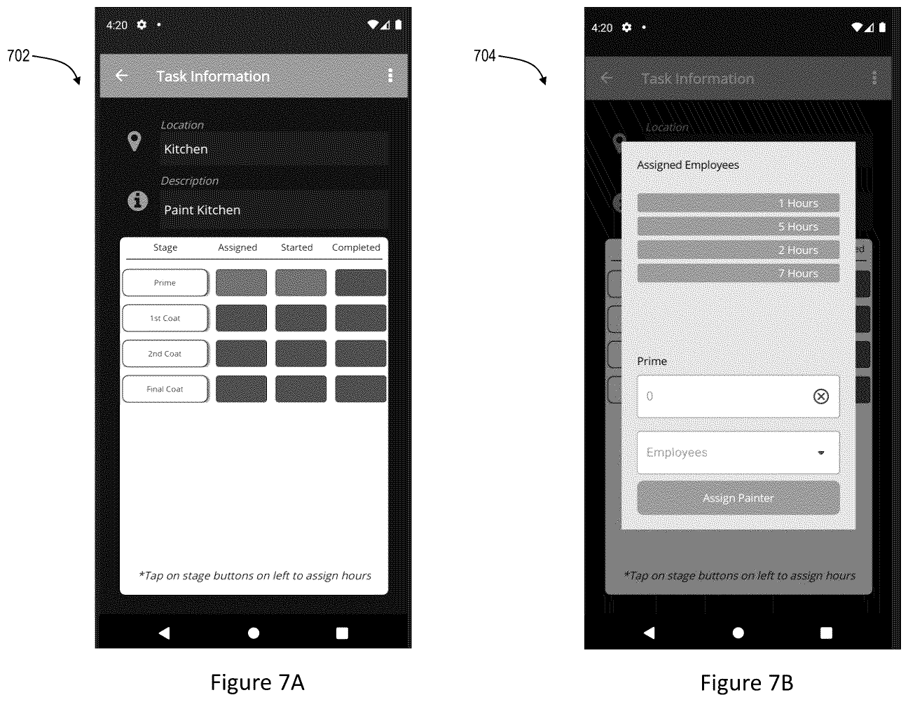

Referring now to FIGS. 7A-7B, shown therein are views of GUIs 702 and 704, according to respective embodiments.

The GUI 702 shows the completion of a task (e.g., “Paint Kitchen” as in the GUI 506 of FIG. 5C) by showing completion of sub-tasks according to colour coding shown therein, as in the GUIs 502, 504 of FIGS. 5A, 5B, respectively.

The GUI 704 shows employees assigned to complete each sub-task and a time budget for each employee to complete the respective sub-task (e.g., a time budget of 1 hour for the “Prime” sub-task).

The GUI 704 may be accessible, viewable, or otherwise programmable from the GUI 702.

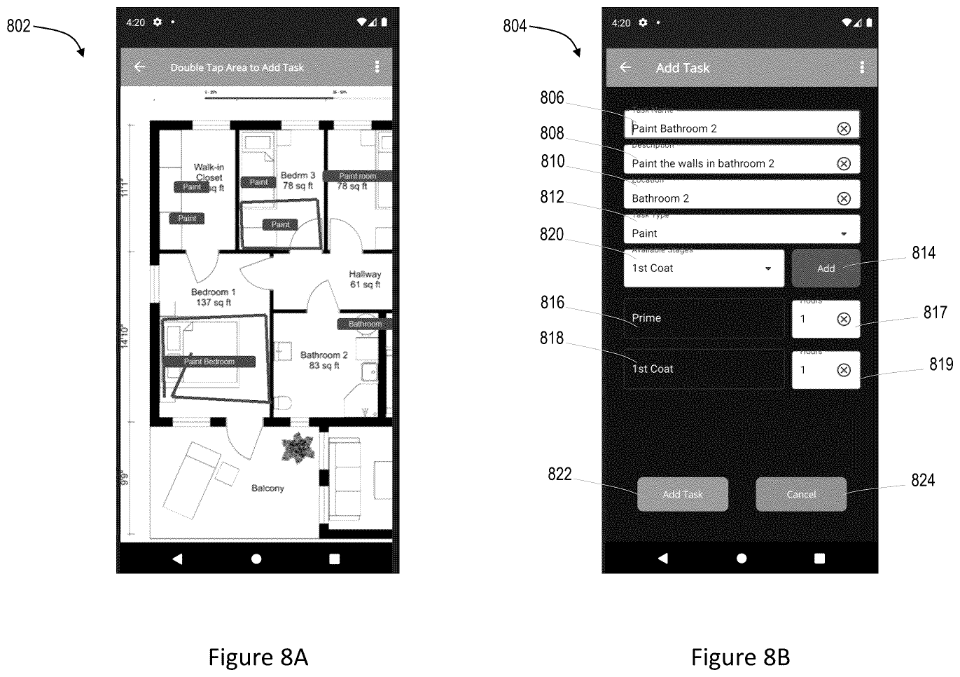

Referring now to FIGS. 8A and 8B, shown therein are GUIs 802, 804 for creating tasks, according to respective embodiments.

In the GUI 802, a floorplan or other physical or schematic representation of a work site is provided, e.g., of a house or apartment. A user of the GUI 802 creates a task (e.g., painting) by clicking on or otherwise selecting an area of the work site (e.g., by drawing a polygon around the area of the work site).

The GUI 804 may be accessible, viewable, or otherwise programmable from the GUI 802.

In the GUI 804, a user creates or adds a task to the GUI 802. The GUI 804 includes a task name 806, a task description 808, a location 810, and a task type 812.

The GUI 804 further includes an adding sub-task button 814 for adding sub-tasks, e.g., the sub-tasks 816, 818 shown in FIG. 8B.

The GUI 804 further includes an ‘available stages’ button 820 for selecting a type of sub-task from a pre-approved list of sub-tasks (e.g., a task whose task type 812 is ‘paint’ may only permit adding certain sub-tasks, e.g., “Prime” as in the sub-task 816.

The GUI 804 further includes a number of hours assigned or allocated to each sub-task. For example, in FIG. 8B, a first time display 817 shows that 1 hour is allocated to the sub-task 816. As a further example, in FIG. 8B, a second time display 819 shows that 1 hour is allocated to the sub-task 818.

The GUI 804 further includes an ‘add task’ button 822 for adding the task to the GUI 802.

The GUI 804 further includes a ‘cancel’ button 824 for declining to add the task to the GUI 802. In an embodiment, clicking the ‘cancel’ button 824 deletes the task name 806, the task description 808, the location 810, the task type 812, the sub-tasks 816, 818, etc., the first time display 817, the second time display 819, etc., and any other data provided to the GUI 804.

The embodiments described herein represent a range of systems, methods, and devices for enhancing web content delivery and user interaction. It should be noted that these embodiments are not mutually exclusive and may intersect or integrate in various implementations. Processes or features from one embodiment may be adaptable or combinable with those from another, providing flexibility and customization in the application of these methods.

While the above description provides examples of one or more apparatus, methods, or systems, it will be appreciated that other apparatus, methods, or systems may be within the scope of the claims as interpreted by one of skill in the art.

1. A task management system for managing a project, the task management system comprising:
a task management server configured to:
create, assign, and track tasks in real time;
continuously monitor progress of the tasks in real time by collecting task data;
analyze the task data to generate real-time progress reports;
synchronize, in real time, updates or changes to detailed worksite information throughout the system;
integrate data streams related to the progress of the tasks and budget utilization to provide a unified view of the status of the project; and
manage subtasks, record time and resource utilization, and analyze to ensure the tasks are evenly distributed;
a database connected to the task management server and configured to:
collect, organize, and manage the detailed worksite information; and
a user terminal connected to the task management server over a network and configured to:
align deadlines of the tasks with a schedule of the project; and
visually manage assignment of the tasks.

2. The task management system of claim 1, wherein the detailed worksite information includes site layouts and safety protocols.

3. The task management system of claim 1, wherein the task management server is further configured to provide a graphical user interface for the user terminal to visually manage the assignment of the tasks on interactive floor plans.

4. The task management system of claim 1, wherein the task management server is further configured to enforce multi-level access controls based on user roles.

5. The task management system of claim 1, further comprising a contractor terminal connected to the task management server over a network, configured to allow contractors and workers to receive the assignments of the tasks, update statuses of the tasks, and report on the progress of the project.

6. The task management system of claim 1, further comprising a client terminal connected to the task management server over a network, configured to provide clients with real-time updates on project status and allow clients to provide feedback or approve completed tasks.

7. A task management device for managing a project, comprising:
a task management module configured to:
create, assign, and track tasks in real time;
continuously monitor progress of the tasks in real time by collecting task data;
analyze the task data to generate real-time progress reports; and
align deadlines of the tasks with a schedule of the project;
a job site management module configured to:
collect, organize, and manage the detailed worksite information; and
synchronize, in real time, updates or changes to detailed worksite information throughout the device;
a task assignment module configured to:
integrate data streams related to the progress of the tasks and budget utilization to provide a unified view of the status of the project; and
a detailed task management module configured to:
manage subtasks, record time and resource utilization, and analyze to ensure the tasks are evenly distributed.

8. The task management device of claim 7, further comprising a multi-level access control module configured to enforce role-based access controls.

9. The task management device of claim 7, further comprising a database configured to store task descriptions, employee assignments, material inventories, and project timelines.

10. The task management device of claim 9, wherein the database is further configured to store progress reports, client feedback, and visual data such as photos and PDF documents.

11. The task management device of claim 7, wherein the task management device is further configured to synchronize data between the task management device and external user terminals over a network, thereby facilitating real-time updates and communication.

12. The task management device of claim 7, wherein the detailed worksite information includes site layouts and safety protocols.

13. The task management device of claim 7, wherein the task management server is further configured to provide a graphical user interface for the user terminal to visually manage the assignment of the tasks on interactive floor plans.

14. A task management method for managing a project, the method comprising:
creating, assigning, and tracking tasks;
continuously monitoring progress of the tasks in real time by collecting task data;
analyzing the task data to generate real-time progress reports;
aligning task deadlines with a schedule of the project;
collecting, organizing, and managing detailed worksite information;
synchronizing updates or changes to the detailed worksite information;
integrating data streams related to task progress and budget utilization to provide a unified view of status of the project;
managing subtasks, recording time and resource utilization, and analyzing to ensure that tasks are evenly distributed.

15. The method of claim 14, wherein the detailed worksite information includes site layouts and safety protocols.

16. The method of claim 14 further comprising providing a graphical user interface to visually manage the assignment of the tasks on interactive floor plans.

17. The method of claim 14 further comprising enforcing multi-level access controls based on user roles.

18. The method of claim 14 further comprising storing, on a database, task descriptions, employee assignments, material inventories, and project timelines.

19. The method of claim 18, wherein the database is further configured to store progress reports, client feedback, and visual data such as photos and PDF documents.
